(19) United States
(12) Patent Application Publication
(10) Pub. No.: US 2002/0030342 A1
(43) Pub. Date: Mar. 14, 2002

(54) Handcycle

(76) Inventors: Christopher Rotz, Orem, UT (US); Scott Nielson, Salt Lake City, UT (US); Christopher Musso, Concord, MA (US); Michael Horito, Sarasota, FL (US)

Correspondence Address: Clifton W. Thompson, THORPE, NORTH & WESTERN, L.L.P., P.O. Box 1219, Sandy, UT, 84091-1219, US

(21) Appl. No.: 09/828,716

(22) Filed: Apr. 5, 2001

Related U.S. Application Data
(60) Provisional application No. 60/194,807, filed on Apr. 5, 2000.

(51) Int. Cl. B62M 1/14

(52) U.S. Cl. 280/250

(57) ABSTRACT

A handcycle, comprising an articulated frame comprising a front frame portion and a rear frame portion pivotably joined and configured so that the handcycle is steerable by pivoting of the front and rear portions relative to each other and a restoring force element operatively coupled to and between the front and rear portions and configured to bias said front and rear portions of the frame to a neutral relative position.

This application is based on, and claims priority from, Provisional U.S. Application Ser. No. 60/194,807 filed Apr. 5, 2000, the disclosure of which is incorporated herein in its entirety by reference.

### BACKGROUND OF THE INVENTION

1. Field of the Invention

The invention relates generally to handcycles. More particularly, the invention relates to an improved handcycle having desirable performance and aesthetic characteristics.

2. Description of the Related Art

Handcycles can be defined as wheeled-vehicles powered by the hands, arms, and upper body, as opposed to legs, which differ from wheel chairs in that they employ some form of drive between the rider providing the power, and the wheels driving the vehicle. Typically, a crank, chain, and gear selection arrangement are used. These are usually adapted from bicycles, as this equipment is already optimized for weight reduction and power transmission in the human powered range required for powering the vehicle over typical terrain where such vehicles are used.

Handcycles are gaining in popularity, particularly as they enable persons who cannot fully use their legs, or are amputees, but which have at least some use of the upper body and arms, to ride for recreation or competitive sport, on a comparable and favorable basis with other similarly situated, as well as persons riding conventional bicycles.

Moreover, because they are fun to ride, and develop the arms and upper body, handcycles are used by persons both with and without any physical challenges. Riders wishing to develop and provide exercise for the upper body and arms, can use the handcycle to isolate this part of the body for training.

Heretofore, handcycle design has developed primarily along the lines of conventional bicycle designs. Basis A, typically tubing is used to form a frame, and, as mentioned, bicycle components have typically been used for the drive system, as well as for brakes, wheels, axils, tires, etc. As mentioned this has proved advantageous because these components are the product of many years of design development towards optimization of weight reduction and performance characteristics with respect thereto. However, as with any vehicle, a dynamic drag can be a factor in its performance. Typically, complex structures of metal tubing provide a significant amount of ergonomic drag. Also, because the structures are relatively more complex, the esthetic aspect of handcycles has heretofore been related to a “rugged beauty” of complexity and structure evidencing rugged design and capability, rather than a more spare aesthetic related to aerodynamic and structural efficiency. A beneficial effect on a rider of a perception that they are riding a vehicle that looks good, should not be over looked. In this context, to the extent that esthetic factors provide a tangible and real effect on the well being of the user such features have a utilitarian function.

One design of handcycles found to be particularly favorable, is an articulated frame having a forward portion including a front drive wheel, drive mechanicals, and a seat for the operator, and a rear portion including two rear wheels, providing a tricycle arrangement rotation of the forward part of the frame, including the front wheel with respect to the rear portion of the frame including the two rearward wheels. An example of such arrangement is disclosed in U.S. Pat. No. 5,853,184 issued Dec. 29, 1998 to Lofgren, et. al. This basic arrangement has been found to work well, but has also been recognized that some means of stabilizing the articulated frame is required, and in the above mentioned disclosure, a dampener is connected between the articulated frame elements to stabilize the vehicle. The dampener apparently reduces the tendency for osculating movement between the two frame elements, particularly found to be a problem at higher speeds.

A vehicle that is light weight, and facilitates rider ingress and egress, is stable, and efficiently uses the power available from the arms and upper body of the rider, is recognized as desirable. Moreover, a vehicle which is aesthetically pleasing, and which reduces aerodynamic drag, is also desirable. Moreover, a vehicle which addresses the particular concerns of physically challenged persons, particularly those which are susceptible to skin breakdown and other injuries possible in using this type of vehicle, is also desirable. Moreover, design goals in such vehicles therefore necessarily include efficiency, accommodation of the particular needs of the rider, adjustability, stability and efficient propulsion are all desirable. The present invention is directed to addressing these design goals.

### SUMMARY OF THE INVENTION

Additional features and advantages of the invention will be apparent from the detailed description which follows, taken in conjunction with the accompanying drawings, which together illustrate, by way of example, features of the invention.

The invention accordingly provides a handcycle comprising an articulated frame formed of a composite material; a dampener providing a restoring force operatively connected between the articulated frame elements; and, an adjustably positional hand crank set carried by a forward frame element.

In a more detailed aspect, the forward frame portion can carry the seat for the rider, which seat can be likewise formed of a composite material, for light weight, and flexible/compliant construction to accommodate a rider and minimize the possibility of skin break down. The forward frame portion can further comprise leg supports, which can be trombone style leg supports, which can be adjusted so to comfortably accommodate riders of different sizes.

In a further more detailed aspect, the dampening element providing a restoring force operatively coupled between the front and rear frame elements, can compromise a mount having an outer element and an inner element, the outer and inner elements being rotatable with respect to each other, the inner and outer elements being coupled together by an elastomeric element configured to be deformed within the elastic range by relative rotation of the inner and outer elements. This mount provides a restoring force biasing the inner and outer elements to a particular rotational relationship. When this mount is placed between the front and rear frame elements it provides a restoring force biasing the two frame elements into a selected relative orientation, that orientation being a non-turning, or straight line configuration tending to keep the handcycle on a straight line course.

In a further more detailed aspect, the arrangement for adjustability in the position of the hand crank can compromise a mounting plate carried by the forward frame element, mounting plate further comprising a number of threaded holes, the mounting plate cooperating with a crank set mounting piece having associated threaded fasteners which can be inserted in selected holes in the mounting plate to relatively position the crank set with respect to the mounting plate and front frame element. Furthermore, the mounting plate can be inclined with respect to the handcycle, so that vertical placement of the crank set is adjustable with front-to-back adjustability of the crank set position.

In a further more detailed aspect, the front-to-rear frame portions can be formed of a cut and fiber-epoxy composite material. The front and rear frame elements can be given a aerodynamic shape and aspect ratio configured to provide improved aerodynamic properties, including decreased aerodynamic resistance in motion through the air.

In a further detailed aspect, the frame components can be given an aspect ratio of approximately 3-1, or better, for improved aerodynamic efficiency.

In a further detailed aspect, the handcycle frame elements can be formed by a pressure molding, or vacuum forming process wherein the elements are formed up, and cured in a mold under pressure at optimum temperature, for improved structural and aesthetic characteristics.

Further features and advantages will become apparent with reference to the following detailed description, taken in conjunction with the appended drawings, which illustrate, by way of example, possible implementations of principles of the invention.

### BRIEF DESCRIPTION OF THE DRAWINGS

FIG. 1 is a front left perspective of a handcycle in accordance with principles of the invention;

FIG. 2 is a left side elevation view of the handcycle of FIG. 1, certain elements being omitted or shown only in outline, for clarity;

FIG. 3 is a top view of the handcycle of FIG. 1, again, certain elements are omitted for clarity;

FIG. 4 is a side elevation view of a rear wheel lug element of the handcycle shown in FIG. 1;

FIG. 5 is a bottom or top view, taken along the line 5-5 in FIG. 4 of the lug shown in FIG. 4;

FIG. 6 is a side cross-sectional view, taken along the line 6-6 in FIG. 4 of the lug shown in FIG. 4;

FIG. 7 is a side elevation view, partially in section, partially in breakaway, of the rear pivot of the handcycle shown in FIG. 1, enlarged and showing further detail of the arrangements relating thereto;

FIG. 8 is an enlarged right side elevation view of the front pivot of the handcycle shown in FIG. 1, shown partially in cross-section and partially in breakaway, illustrating further details of the arrangements relating thereto;

FIG. 9 is a cross-sectional view, taken along line 9-9 in FIG. 8, showing a restoring force element embodied in the pivot shown in FIG. 8;

FIG. 9A is a cross-sectional view, taken along line 9-9 in FIG. 8, of the restoring force element shown in FIGS. 8 and 9 in a rotated aspect;

FIG. 10 is a side elevation view of an alternate embodiment of a restoring force element which could be used in connection with the front or rear pivot of the handcycle shown in FIG. 1;

FIG. 11 is a cross-sectional view, taken along line 11-11 in FIG. 10 of a restoring force element in accordance with principles of the invention;

FIG. 12 is a cross-sectional view, taken along line 12-12 in FIG. 10 of a damping element incorporated in the same structure shown in FIG. 10;

FIG. 13 is a top view of a portion of the crank support pillar 46 showing the incline surface portion 48 thereof and the mounting plate for the hand crank of the handcycle shown in FIG. 1;

FIG. 14 is a front or rear elevation view of a hand crank mount mountable on the plate shown in FIG. 13 disposed on the incline surface portion of the crank support pillar portion of the frame of the handcycle shown in FIG. 1;

FIG. 15 is a side elevation view, taken along line 15-15 in FIG. 14 of the hand crank mount shown in FIG. 14; and

FIG. 16 is a bottom view, taken along line 16-16 in FIG. 14 of the hand crank mount shown in FIG. 14.

### DETAILED DESCRIPTION OF THE PREFERRED EMBODIMENTS DETAILED DESCRIPTION

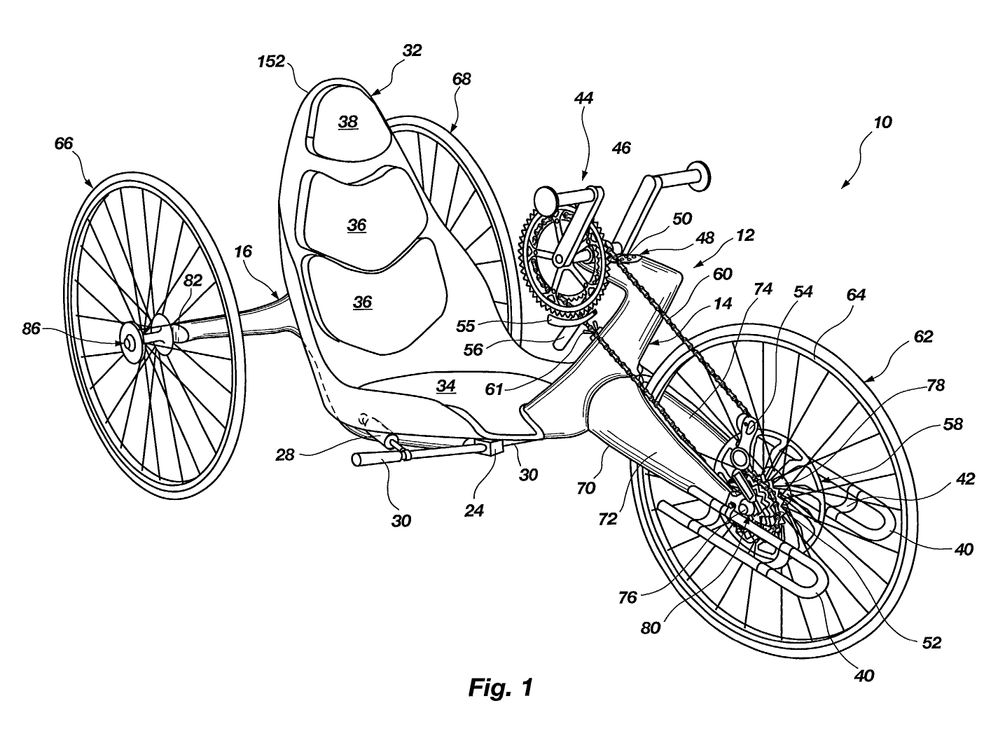

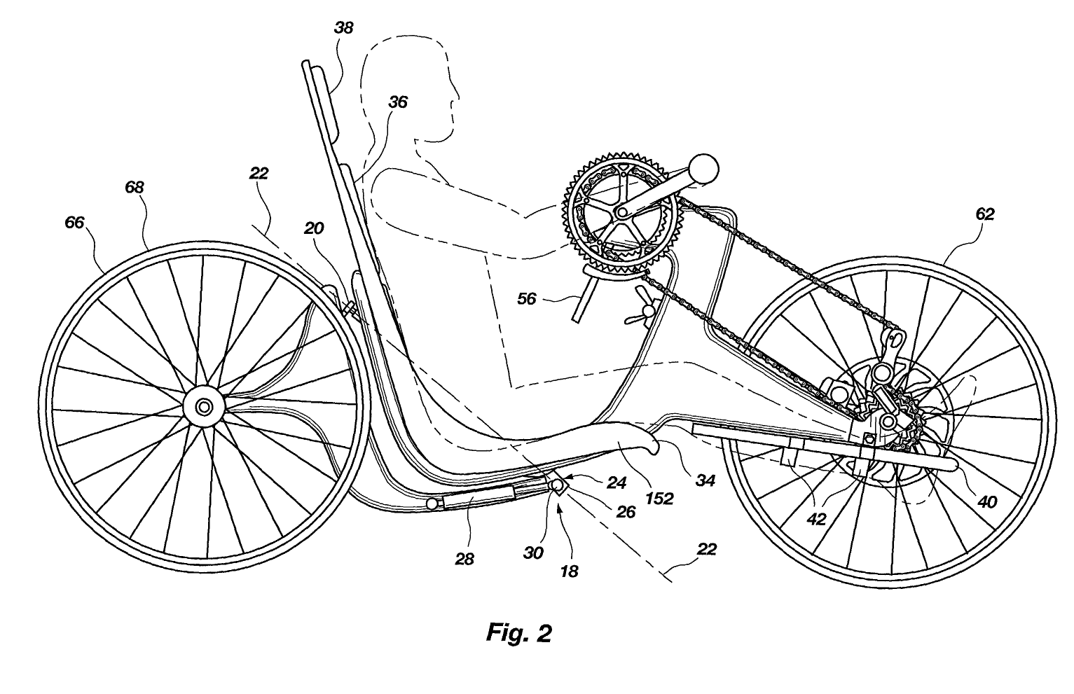

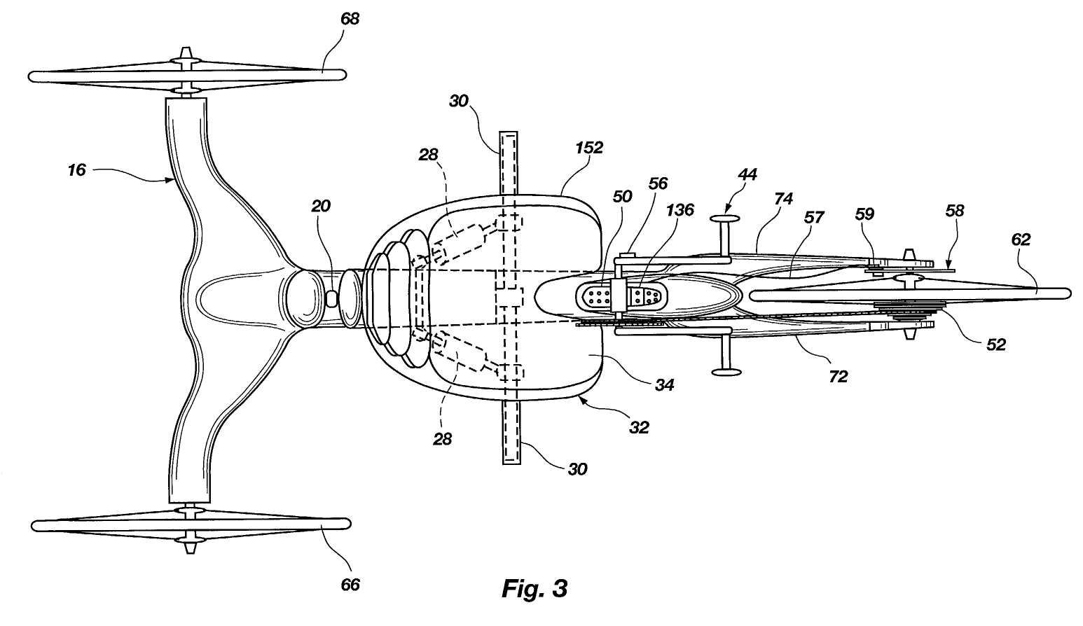

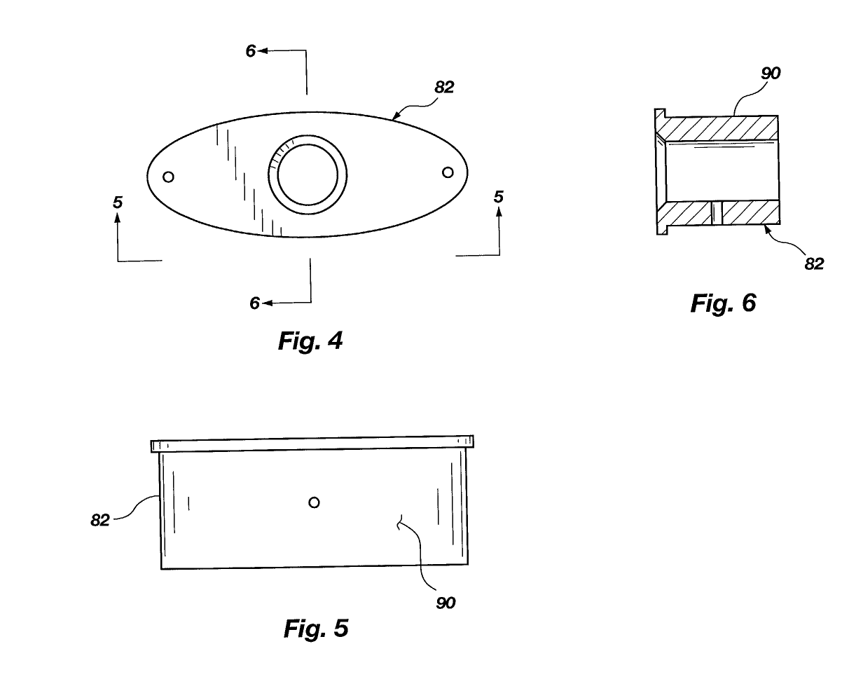

With reference to FIGS. 1, 2 and 3 of the drawings, which are given by way of example and not by way of limitation, the invention is embodied in a handcycle 10 in one embodiment comprising a frame 12 having a front frame portion 14 and a rear frame portion 16 pivotably coupled together so that they can rotate with respect to one another to facilitate steering of the handcycle. Front and rear pivots, 18 and 20 respectively, are disposed intermediate the front and rear frame portions. These pivots comprise mechanical structure facilitating rotation about a rotation axis 22 which comprises a axis of relative rotation between the front frame portion and the rear frame portion.

The frame 12 therefore comprises an articulated frame facilitating relative pivoting between the front and rear frame portions, 14, 16 and also provided is a restoring force element 24 which biases the two frame portions into a neutral relative rotational position corresponding with straight forward directability, or in other words a non-turning position where the frame portions are in alignment and the handcycle in motion proceeds in a substantially straight direction.

The restoring force element 24 in the preferred embodiment comprises a LOVEJOY ROSTA suspension 26 which are widely commercially available from LOVEJOY PRODUCTS of Downers Grove, Ill. The 27 X series mounts are recommended. The restoring force element will be described in further detail below.

In one embodiment, a damning element 28 is provided to damp relative pivoting motion between the front and rear frame portions 14, 16. This is particularly useful in reducing oscillatory motion between the front and rear frame portions at higher speeds. The dampening element in one element is a simple pneumatic piston device incorporating an orifice which allows low frequency, relative pivoting, but which inhibits high frequency relative pivoting. In other words, it allows operator initiated turning motions, but resists oscillating relative motions at higher frequencies, such as would be the occasion by a resiment fiberatory osculation occuring at high speeds travel of the handcycle 10.

In one embodiment, the dampening element can be connected between one of two turning handles 30 extending laterally from a forward part of the rear frame portion, as are known in the art to facilitate turning of the handcycle at low speeds. A seat 32 is provided for the rider, formed of a composite material as well. The seat further comprises a padded seat portion 34, comprising a foam or other material, which is configured to minimize discomfort and skin breakdown of the rider, as well as one or more backrest padded portions 36 formed of the similar material, and may further comprise a head pad portion 38 to cushion and support the head of the rider.

Trombone-style footrests 40, carried by the front frame portion 14. These are adjustable, as are known in the art, to accommodate riders of different sizes.

A crank set 44 is also carried by the front frame portion 14 and its position is adjustable, as shall be further discussed below, to accommodate different size riders, and rider preferences. In this regard, the front frame portion includes a crank support pillar 46 further comprising an inclined surface 48 which supports a crank set mounting plate 50, which allows the crank set to be adjusted upwardly and outwardly as well as inwardly and downwardly, at the same time minimizing the change in the distance between the crank set and the front gear sprocket 52. The incline surface 48 in one embodiment is plainer, but as can be appreciated, the surface could also be curved to further minimize the change in distance between the crank set and front sprocket. As well be appreciated, a derailier 54 is employed which allows considerable variation and the distance between the crank set and sprocket.

Also carried by the crank set pillar 46 is a handbrake lever 56 which is operatively coupled to a disk brake 58 disposed opposite the gear cluster 52.

As well be appreciated, the crank set, derailier 44, gear cluster 52 and derailier 54 are conventional, and are such as used with bicycles as is the disk brake 58 employed, and the arrangements for these elements are as known in the art and there operation being well known detailed discussion will be omitted.

Likewise, a chain 60 drives a front wheel 62, therefore comprising a drive wheel, in a conventional manner, and these elements are conventional bicycle components in one embodiment. As will be appreciated, a rim 64 of the front wheel can comprise instead a light weight composite, and such wheels are known. Furthermore, rear wheels 66, 68 are also conventional bicycle wheels in the illustrated embodiment, and can likewise be replaced by wheels having rims 64 formed of a light weight composite. Rear wheels can be disposed vertically, or can be given a inward camber as is known in the art.

As will be made apparent from the following discussion, at certain places on the articulated frame 12 metal elements are employed. This is because certain points, such as where the pivot pivots 18, 20 are located, and the wheels, 64, 66, 68 are connected to the frame, and other places, metal is better suited to the surface roads applied than carbon fiber composite. As an example, the front frame portion 14 comprises a front wheel fork 70 comprising two forwardly extending arms 72, 74 terminating forwardly at metallic lugs 76, 78 which carry the front wheel axil 80. These front wheel lugs are formed of aluminum alloy in the illustrated embodiment. They can be attached to the carbon fiber frame 12 after it has been cured, using an adhesive, such as a compatible epoxy, or can be attached by cured co-curing process wherein the lugs are placed in the mold with the carbon fiber lay up and become integral with the frame as the lay up is cured in the mold.

Likewise, the crank set mounting plate 50 is formed of aluminum alloy and also is attached to the crank support pillar 46 at the inclined surface 48 by adhesive, or is co-cured and forms a portion of the inclined surface. Rear wheel lugs 82, 84, also formed of aluminum alloy, receive and support the rear wheel axils 86, 88 in a candor lever fashion, and are also either co-cured with the rear frame portion 14 composite lay up, or are afterwards inserted therein with a compatible epoxy or other adhesive to form an integral part of the structure. Further details concerning the rear wheel lugs will be appreciated with FIGS. ______ which illustrate different views of the rear wheel lugs. It can be appreciated that they are telescopely received in the rear frame portion if inserted therein after the frame is cured, and a large bonding surface area 90 facilitates such attachment by adhesive, or by a co-curing process.

With reference to FIG. 7, in further detail the rear pivot 20 comprises a ball joint 92 deposed in an immediate 2 aluminum alloy mounts 94, 96 which cooperate with aluminum alloy plates 98, 100, and the walls 102, 104 of the rear frame portion 16 and the front frame portion 14 respectively to integrate the rear pivot with the articulated frame 12. In one embodiment, the mounts are placed in the molds with the lay ups of the front and rear frame portions, and are co-cured therewith. In another embodiment, at least one end of each frame element is left open, and the mounts are inserted through the cured hollow frame portions to holes formed therein at the appropriate locations 106, 108 where portions of the mount protruding out of the frames are brought through the holes and the mounts are attached by adhesive, or a combination of adhesive and fasteners through the plates 98, 100 into the mounts 94, 96 respectively. As will be appreciated, the mounts and the plates distribute stresses from forces transferred through the pivot 20 to larger area of the walls 102, 104 of the frame portions 16, 14 to reduce strains and fatigue.

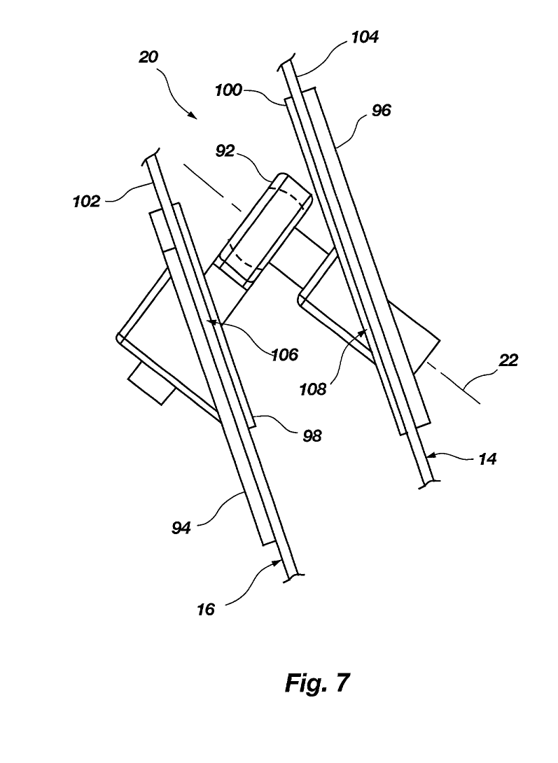

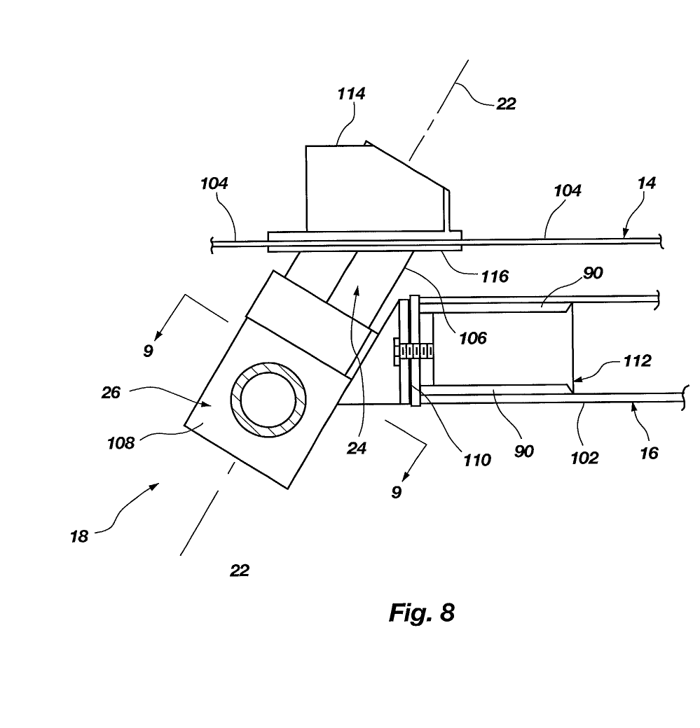

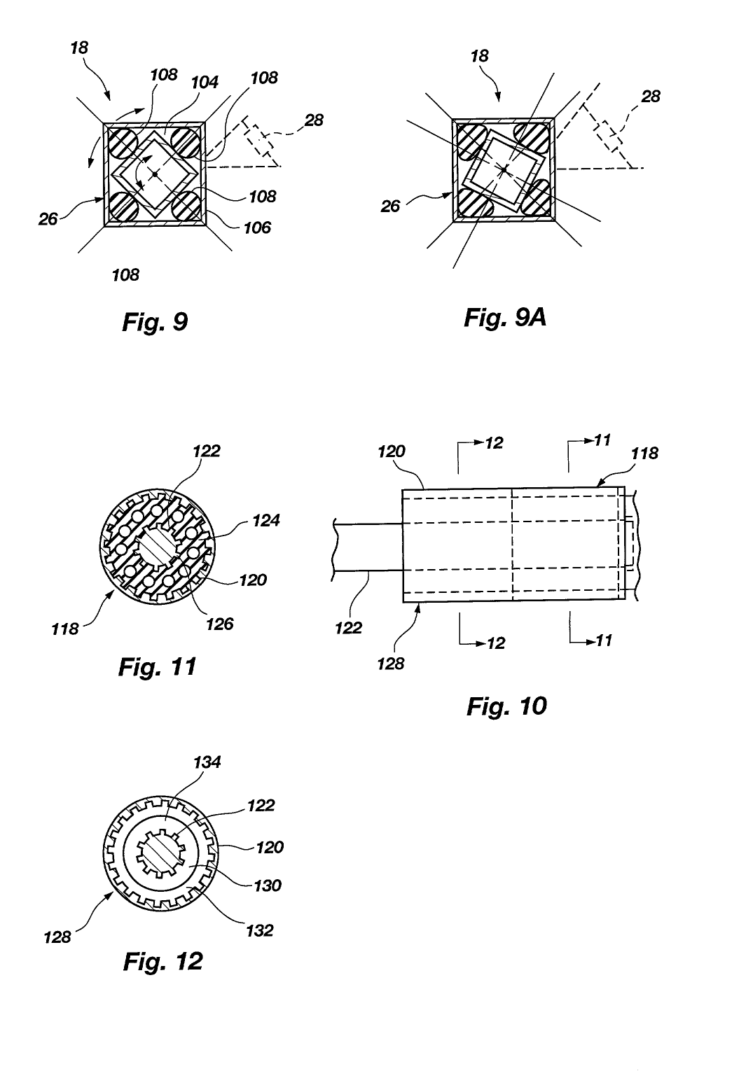

Turning to FIGS. 8, 9, and 9A further details of the front pivot 18 will be appreciated. The pivot includes a restoring force element 24, as mentioned, which further includes a LOVEJOY ROSTA suspension mount 26 in the illustrated embodiment. The handles, 30, are welded to the suspension joint 26 and extend laterally to the right and left under the seat (32 in FIG. 1) to the right and left, which is perpendicular to the plane of FIG. 8. The restoring force element which comprises the ROSTA suspension mount includes an outer element 106 and an inner element 104 which are mounted co-axially and pivot with respect to one another. Intermediately inner and outer elements are at least 1, but in the illustrated embodiment, 4 elastomeric elements 108 which deform elastically as the inner and outer elements rotate with respect to one another. The outer element 106 is connected by welding in the illustrated embodiment, to a mount 110 which bolts to a forward lug 112 received in the forward end of the rear frame portion 16. A bonding surface 90 is sufficient area is provided for good bonding between the lug and the carbon fiber resident composite wall 102 of the rear frame portion. Again, this attachment can be by means of an adhesive, or a co-curing process.

In one embodiment, the LOVEJOY ROSTA amount can be configured to provide both a restoring force and dampening of motion between the inner and outer elements, 106, 108 respectively, and by extension, the front and rear frame portions. In one illustrated embodiment a dampening member 28, is provided in addition to the dampening provided by the ROSTA mount 26. As mentioned, this dampening method can be disposed between the handle 30 and the front frame portion 14 at a location behind the seat 32 (this is better appreciated with reference again to FIG. 1). Returning to FIGS. 8, 9, and 9A, an upper front pivot mount 114, cooperates with a plate 116 and the wall 104 of the front frame portion 14 to transfer forces from the pivot 18 to the front frame portion, and vise versa. As described above, this arrangement can be co-cured, or installed in the hollow frame after it is cured and been removed from the mold.

With reference now to FIGS. 10, 11 and 12, in another embodiment the ROSTA amount could be replaced by another force restoring element 118 comprising an outer element 120 and an inner element 122 and an elastomeric element 124 disposed there between. The inner and outer elements further comprise splines 126 so that sheer forces can be transferred between the elastomeric element and the inner and outer elements. As will be appreciated, with relative rotation of the inner and outer elements the elastomeric element deforms within the elastic range and provides a restoring force tending to bias the inner and outer element to a specific rotational relationship corresponding with a neutral orientation of the front and rear frame elements when the force restoring element 118 is used to interconnect the front and rear frame portions of the articulated frame 12. In this embodiment, the structure further comprises a dampening element 128 which is adjacent and co-axial with the restoring force element and included in the same structure and makes use of the same inner and outer elements 122, 120 respectively. Two dampening elements 131, 132 are provided co-axially between the inner and outer elements, and surface interaction at an interface 134 there between provides dampening. Alternatively, a discus substance can be provided either in the interface, or comprising one or both of the dampening elements 130, 132 to provide dampening. As will be appreciated, this embodiment also separate dampening elements 28 can be provided.

In this connection, it will be appreciated that while the connection between the dampening elements 28, and the front portion 14 of the frame is not shown in the figures, it comprises an aluminum alloy mount and plate similar to that previously described for the pivots. Arrangements must be made so that there is clearance between the dampening elements 28 and the rear frame portion 16 as they will extend over the rear frame portion below the seat to the right and to the left as the frame 12 articulates.

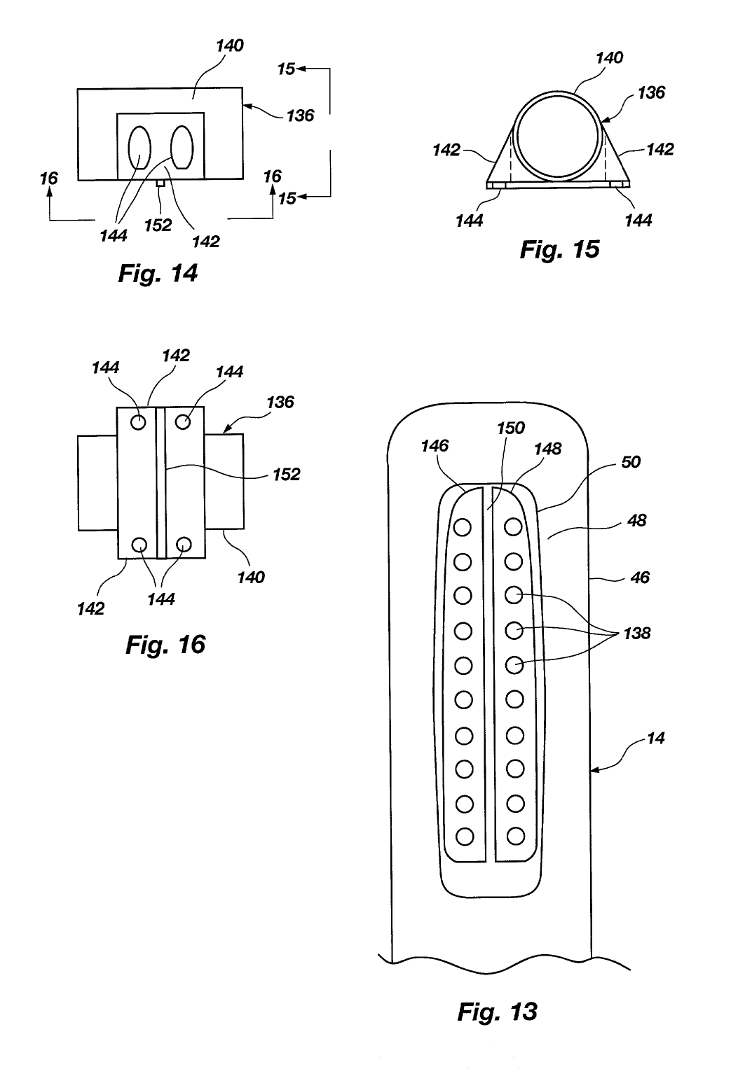

With reference to FIGS. 13, 14, 15, and 16, provisions for mounting the crank set (44 in FIG. 1), include the mounting plate 50 mentioned, which is formed of an aluminum alloy, co-cured with, or bonded to the incline surface 48 of the crank set pillar 46 of the front frame portion 14. Our crank set mount 136 is adjustably positionable on the mounting plate 50 by means of threaded fasteners (not shown) received in threaded holes 138 in the mounting plate. The crank mount further comprises a tubular portion 140 which carries bearings (not shown) rotatably carrying the crank set, and wing portions 142 defining holes 144 for threaded bolt fasteners (not shown). In one embodiment, the mounting plate 150 comprises two raised portions 146, 148 which define a channel 150 there between which cooperates with a downwardly extending flange 152 to further secure the crank set mount 136 to the mounting plate 50. As will be appreciated, the downward extending flange 152, slides in the channel 150 when the mounting bolts are removed allowing the crank set mount 136 to be moved forwardly and rearwardly (and at the same time upwardly or downwardly) along the inclined face 48 including the mounting plate 50. Turning now again to FIGS. 1, 2, and 3 more particularly, it will be appreciated that details of the lay up of the articulated frame comprising the front frame portion 14 and rear frame portion 16 will assist in understanding how the handcycle is made in accordance with one embodiment.

As mentioned, the frame is formed by internal pressure molding in one embodiment. Aluminum mold tooling is used, and an internal bladder formed of nylon. Carbon fiber resin lay-ups are placed in the mold, which can comprise a plurality of pieces. In practice, once strategy is to place the lay-ups in the various mold sections with overlapping flaps to be fitted inside the lay-up of adjacent fitting mold portions with the bladder in between, and when the mold portions are affixed together, by clamping or bolting, and the bladder is inflated by air pressure the lay-up is consolidated and the overlapping flaps are consolidated against the other portion of the lay-up in the adjacent mold section. Providing a unified structure after curing, which occurs in the mold at approximately 250° in one embodiment, but which of course will vary depending on the materials used, specifically the curing temperature of the particular resin being the predominant factor.

As will be appreciated, depending on the location in the articulated frame, the lay-up will be unidirectional or comprise layers laid up in differing directions. For example, these may be placed in orthogonal X and I directions, with other layers running plus or minus 45°. Other angular relationships can be used. The particulars of the lay-up are conventionally determined from a finite element analysis of stresses in the frame when subjected to design service loads.

Moreover, unidirectional and weave layers can be used, where appropriate, to achieve the best configuration for economical handling of stresses in the frame. In general, the walls of the frame will be about one-sixteenth of an inch thick, and comprise four to eight layers in the lay-up. Areas of particularly high stress will be thicker and have more layers as needed.

The seat 32 is also formed of a carbon fiber composite shell 152 which can be molded, including laying it up within a single sided mold, and curing at room temperature. The bucket shape of the shell 152 provides sufficient strength, while allowing also sufficient flex for comfort, and an efficient design in terms of supporting the weight of the rider as needed, while minimizing the weight of the seat 32. The pads 34, 36, 38 can be attached by adhesive or by co-curing process.

In general, it will be appreciated that other elements, such as the handbrake, disc brake, or water bottle (not shown) can be mounted on the frame with the use of aluminum or metallic alloy lugs attached by adhesive processes or co-cure, in a manner similar to that described above with respect to the other lugs and metallic elements attached to and cooperating with the composite frame 12 of the handcycle 10. It will also be appreciated that the arrangements shown in the illustrated embodiment are only illustrative of the possible embodiment of the principles and invention in a handcycle and that numerous other arrangements, features and aspects of the invention can be included in other embodiments of the invention, but still be within the scope of the invention set forth in the appended claims, which is not intended to be limited in any respect by the fact that particular illustrative examples have been illustrated and described herein.

1. A handcycle, comprising:
an articulated frame comprising a front frame portion and a rear frame portion pivotably joined and configured so that the handcycle is steerable by pivoting of the front and rear portions relative to each other;
a restoring force element operatively coupled to and between the front and rear portions and configured to bias said front and rear portions of the frame to a neutral relative position.

2. A handcycle as set forth in claim 1, wherein the front frame portion is coupleable to a drive wheel located forewardly, and the rear frame portion is coupleable to two rear wheels.

3. A handcycle as set forth in claim 1, wherein the restoring force element further comprises a deformable element deformable in the elastic range when the front and rear frame portions pivot with respect to one another from the neutral relative position.

4. A handcycle as set forth in claim 3, wherein the restoring force element further comprises:
a first portion coupled to one of the front and rear frame portions and
a second portion coupled to the other of the front and rear frame portions
an elastomeric element comprising said deformable element, said elastomeric element cooperating with the first and second portions so that as the first and second portions rotate with respect to each other, the elastomeric element is deformed in the elastic range, giving rise to said restoring force.

5. A handcycle as set forth in claim 1, further comprising a damping element configured to damp relative pivoting motion between the front and rear frame portions, whereby undesired oscillating pivoting relative motion of the front and rear frame portions is reduced.

6. A handcycle as set forth in claim 4, further comprising a damping element operatively coupleable to the first and second portions of the restoring force element configured to damp relative pivoting motion between the front and rear frame elements, whereby undesired oscillating pivoting relative motion between the front and rear frame elements is reduced.

7. A handcycle as set forth in claim 1, wherein the articulated frame comprises a composite material.

8. A handcycle as set forth in claim 7, wherein the composite material comprises carbon fiber.

9. A handcycle as set forth in claim 8, wherein the frame is molded.

10. A handcycle as set forth in claim 9, wherein the frame comprises a composite material layup consolidated by differential pressure while in a mold.

11. A handcycle as set forth in claim 1, further comprising a crank set mounting surface carried by the frame, a crank set mount adjustably carried by the mounting surface, and a crank set carried by the crank set mount, whereby the position of the crank set with respect to the frame is adjustable by adjusting the relative position of the crank set mount on the crank set mounting surface.

12. A handcycle, comprising a frame including a composite material layup consolidated by differential pressure while in a mold.

13. A handcycle as set forth in claim 12, wherein said frame is formed by a molding process wherein a pressure differential holds the composite material against a mold while it is curing.

14. A handcycle as set forth in claim 12, wherein said frame is formed hollow and further comprises at least a portion of a bladder disposed within said frame, said bladder being configured to consolidate the composite material layup during manufacture.

15. A handcycle as set forth in claim 12, wherein the composite material comprises a carbon fiber.

16. A handcycle as set forth in claim 15, wherein the frame further comprises at least a portion of a bladder disposed within said frame, said bladder being configured to consolidate the composite material layup during manufacture by inflation by air while the frame is disposed within a mold.

17. A handcycle as set forth in claim 16, wherein the bladder comprises a nylon material.

18. A handcycle as set forth in claim 15, wherein the frame is cured at a temperature above room temperature.

19. A handcycle as set forth in claim 12, wherein the frame is configured so as to be articulatable and comprises a front portion and a rear portion pivotably joined so that the handcycle is steerable by relative pivoting of the front and rear frame portions.

20. A handcycle as set forth in claim 19, further comprising a restoring force element disposed intermediate the front and rear frame portions and configured to bias the frame portions to a neutral relative pivot position from other relative positions tending to turn the handcycle.

21. A handcycle as set forth in claim 20, further comprising a damper disposed between the front and rear frame portions configured to reduce oscillatory relative pivoting motion between the front and rear frame portions.

22. A handcycle, comprising:
a frame;
a mounting surface supported by the frame;
a hand crank mount carried on the mounting surface, said hand crank mount being configured to rotatably carry a handcrank and said handcrank mount being positionable with respect to the mounting surface in at least two different locations, whereby the position of the handcrank with respect to the frame is adjustable.

23. A handcycle as set forth in claim 22, wherein the mounting surface is planar.

24. A handcycle as set forth in claim 22, wherein the mounting surface is inclined.

25. A handcycle as set forth in claim 22, wherein the mounting surface defines a plurality of threaded holes configured to receive threaded fasteners configured to affix the hand crank mount to the mounting surface at the plurality of locations.

26. A handcycle as set forth in claim 22, wherein the frame further comprises a composite material.

27. A handcycle as set forth in claim 22, wherein the frame further comprises a front frame portion and a rear frame portion pivotably joined and configured so that the handcycle is steerable by pivoting of the front and rear frame portions relative to each other; the handcycle further comprising a restoring force element operatively coupled to and between the front and rear portions and configured to bias said front and rear portions of the frame to a neutral relative position, whereby the frame of the handcycle is biased to return to a neutral relative position of the front and rear portions from other relative positions.
